(19) United States
(12) Patent Application Publication
(10) Pub. No.: US 2022/0381204 A1
(43) Pub. Date: Dec. 1, 2022

(54) AIR FLOW HEATER ASSIST BY E-TURBO

(71) Applicant: DAF Trucks N.V., Eindhoven (NL)

(72) Inventors: Roel PETERS, Heythuysen (NL); Thomas VIJLBRIEF, Oirschot (NL); Petrus Cornelis Gerardus DE KOK, Heeze (NL)

(21) Appl. No.: 17/572,725

(22) PCT Filed: Jul. 21, 2020
(86) PCT No.: PCT/NL2020/050476

§ 371 Date: Jan. 11, 2022

(30) Foreign Application Priority Data
Jul. 22, 2019 (NL) 2023547

(51) Int. Cl. F02M 26/34; F01N 3/20; F02B 37/10; F02B 39/10; F02M 26/05; F02M 35/10

(52) U.S. Cl. CPC F02M 26/34; F01N 3/2013; F01N 3/2033; F01N 3/2066; F02B 37/10; F02B 39/10; F02M 26/05; F02M 35/10255

(57) ABSTRACT

It is aimed to provide an internal combustion engine (10) comprising: an exhaust line (13) configured to receive exhaust gas from the internal combustion engine (10). An intake line (12) is configured to supply pressurized air from an air intake to the internal combustion engine. A heater (20) is disposed adjacent the exhaust line (13) to generate heat that is transported via the exhaust line to an exhaust aftertreatment system (30). A bypass line (11) controllably connects the intake line to the exhaust line to bypass the engine An electric flow generator (40) is arranged in the intake line and/or bypass line between the air intake and the inlet opening to supply intake air to the exhaust line; and a control system is arranged to selectively control the bypass line (11) to provide pressurized intake air from the electric flow generator, via the inlet opening (17) to supply intake air to the exhaust line for transporting heat generated by the heater towards the aftertreatment system.

### BACKGROUND

In modern day diesel engines, measures are taken to minimize fuel consumption and harmful emissions. The emissions of diesel soot and NOx can be reduced in an engine aftertreatment system (EAS). Typical components of such an aftertreatment system may be a diesel particulate filter to capture soot, and an SCR (Selective Catalytic Reduction) catalyst that converts NOx into harmless products also known as the deNOx process. Aftertreatment systems may further have a diesel oxidation catalyst (DOC) and/or a diesel particulate filter (DPF), but also other configurations are possible such as sDPF, PNA, TWC, known to the skilled person etc. Typically the reactivity of aftertreatment systems increases when temperature of the catalyst material and the exhaust gas increases at least up to a certain temperature. In order to quickly reach a high conversion efficiency of the after treatment system after engine start, a heater may be used to heat the after treatment system to an operating temperature, which may be around 300-400° C. In normal operation, the aftertreatment can be heated by residual heat from the combustion engine. However, the temperature of the exhaust gas is often limited, especially during engine idle or other situations where the exhaust gas flow is relatively low. In these conditions the amount of enthalpy that can be added to the exhaust gas flow is also limited by a certain maximum exhaust gas temperature, in order not to damage the aftertreatment system. However, the catalyst material itself is still under the target temperature. In such conditions only a maximum amount of heat enthalpy can be transferred from the heater to the aftertreatment system, since the maximum temperature should not be exceeded, in view of chemicals and coatings present in the aftertreatment system. Thus, heating the aftertreatment system may require time longer than desirable, during which the system is not functioning optimally. It is an object of the invention to generate more enthalpy without exceeding the exhaust gas temperature limit, and therewith increasing the warm-up speed of the after treatment system.

### SUMMARY

It is an aspect of the present invention to alleviate, at least partially, the problems discussed above by an internal combustion engine comprising: an exhaust line configured to receive exhaust gas from the internal combustion engine and an intake line configured to supply pressurized air from an air intake to the internal combustion engine. A heater is disposed adjacent the exhaust line to generate heat that is transported via the exhaust line to an exhaust aftertreatment system. A bypass line controllably connects the intake line to the exhaust line to bypass the engine, the bypass line in fluid communication with the exhaust line through an inlet opening in the exhaust line upstream of the heater. An electric flow generator is arranged in the intake line and/or bypass line between the air intake and the inlet opening to supply intake air to the exhaust line. A control system is arranged to control the heater and selectively control the bypass line and the electric flow generator, to provide pressurized intake air from the electric flow generator, via the inlet opening to supply intake air to the exhaust line for transporting heat generated by the heater towards the aftertreatment system.

Accordingly air flow from the flow generator is used with the purpose of increasing the exhaust mass flow and therewith allowing the heater or heater to generate more enthalpy without exceeding the exhaust gas temperature limit, and therewith increasing the warm-up speed of the after treatment system.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 shows a simplified schematic representation of a system setup of an internal combustion engine;

FIG. 2 an shows an embodiment with a conventional turbo compressor arrangement;

FIG. 3 shows an embodiment with an e-turbo compressor arrangement;

FIG. 4 shows an embodiment that is a variation of FIG. 3; and

FIG. 5 shows yet another configuration of an electric flow generator arranged in the intake line/bypass line.

FIG. 6 further exemplifies a control scheme 500 executed by control system 50 (see FIG. 1).

### DETAILED DESCRIPTION

Unless otherwise defined, all terms (including technical and scientific terms) used herein have the same meaning as commonly understood by one of ordinary skill in the art to which this invention belongs as read in the context of the description and drawings. It will be further understood that terms, such as those defined in commonly used dictionaries, should be interpreted as having a meaning that is consistent with their meaning in the context of the relevant art and will not be interpreted in an idealized or overly formal sense unless expressly so defined herein. In some instances, detailed descriptions of well-known devices and methods may be omitted so as not to obscure the description of the present systems and methods. The term “and/or” includes any and all combinations of one or more of the associated listed items. It will be further understood that the terms “comprises” and/or “comprising” specify the presence of stated features but do not preclude the presence or addition of one or more other features. All publications, patent applications, patents, and other references mentioned herein are incorporated by reference in their entirety. In case of conflict, the present specification, including definitions, will control.

The route of the added air mass flow can have several embodiments, as the figures below show, and may depend on the type of flow generator that is used. For example, the air can be added upstream or downstream of the turbine, if applicable. Furthermore, the air might be fed from upstream or downstream of a compressor, if applicable. In case of the flow generator being an EGR pump, it might reverse normal flow direction to feed air mass flow to the exhaust. A flow generator, e.g. an e-turbo may be added to increase the bulk exhaust gas mass flow. This secondary device can be an electrical compressor, an e-turbo, an EGR pump, or a turbocharger mechanically coupled to the crankshaft, e.g. a SuperTurbo or supercharger

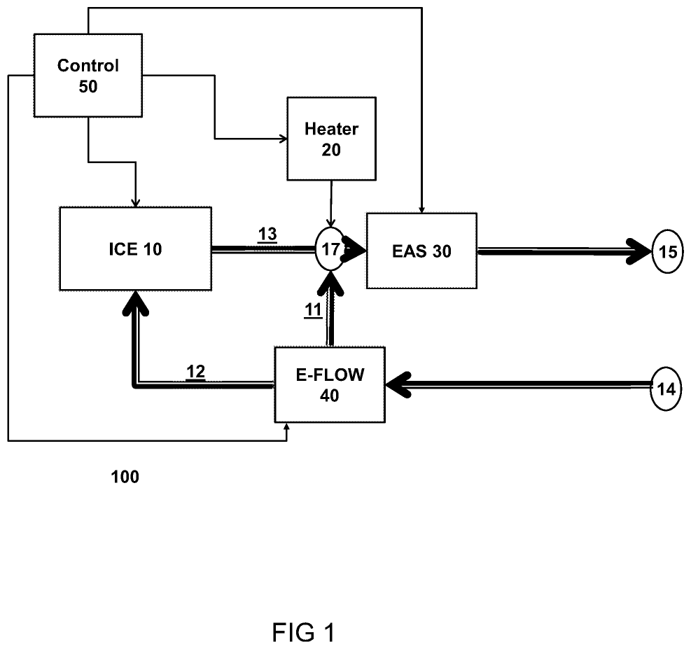

FIG. 1 shows a simplified schematic representation of a system setup 100 of an internal combustion engine (ICE 10) and a typical aftertreatment system (EAS 30). The EAS system may comprise a hydrocarbon (HC) dosing unit, a Diesel Oxidation

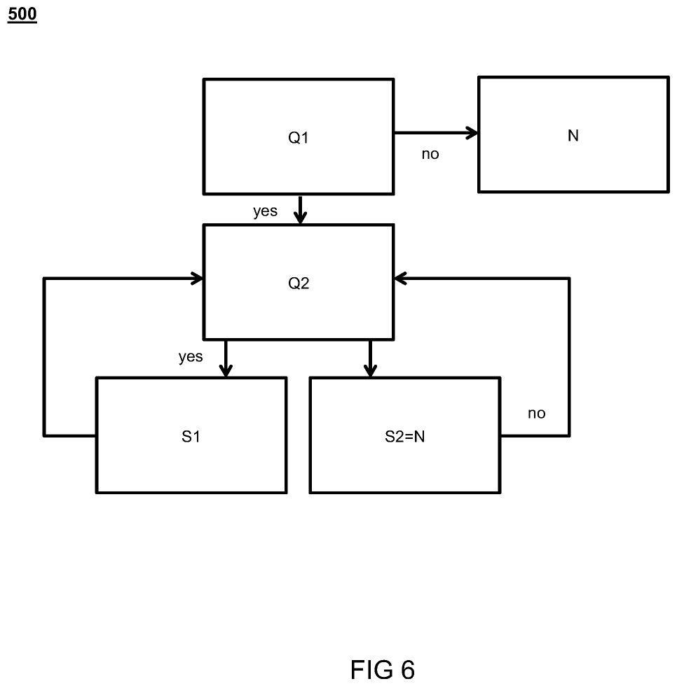

Catalyst (DOC), a Diesel Particulate Filter (DPF), a Urea dosing unit, a Selective Catalytic Reduction catalyst (SCR), an Ammonia Slip Catalyst (ASC) and a Control Module (CM) placed downstream in the exhaust line 13 of the ICE 10 typically including a turbo compressor. This setup is conventional, in the sense that the system elements are known to the skilled person. EAS control 50 in FIG. 1 can be provided on the basis of NOx sensor data or a model. This means that this sensor is used indicatively for the control of NOx out of the system, and therefore for the dosing of DEF fluid, which implies the functioning of part of the EAS. In addition, in addition to a NOx sensor, other sensors may be used, for example flow sensors, chemical substance sensors, etc., that can indicate whether the aftertreatment system is affected by degradation. According to an aspect of the invention internal combustion engine (ICE 10) comprises an exhaust line 13 configured to receive exhaust gas from the internal combustion engine 10 and an intake line 12 configured to supply pressurized air from an air intake 14 to the internal combustion engine 10. A heater 20 is disposed adjacent the exhaust line 13 to generate heat that is transported via the exhaust line 13 to an exhaust aftertreatment system (EAS) 30. A bypass line 11 controllably connects the intake line 12 to the exhaust line 13 to bypass the engine 10, the bypass line 11 in fluid communication with the exhaust line 13 through an inlet opening 17 in the exhaust line. De inlet opening may be provided upstream, downstream or in a turbine arranged in the exhaust line 13. An electric flow generator (E-Flow) 40 is arranged in the intake line 12 and/or bypass line 11 between the air intake 14 and the inlet opening to supply intake air to the exhaust line. A control system 50 is arranged to control the heater 20 and to selectively control the bypass line 11 and/or the electric flow generator 40, to provide pressurized intake air from the electric flow generator 40, via the inlet opening 17 to supply intake air to the exhaust line 13 for transporting heat generated by the heater 20 towards EAS 30. The control system 50 and its control steps will be further discussed in relation with FIG. 6. As will also be illustrated in the subsequent figures, the electric flow generator 40 is controlled, in normal operating conditions, by the engine operating control 50 to achieve certain targets, such as engine out emmissions, fuel economy, driveability requirements, etc. During cold start or in other conditions where the operating temperature of the EAS 30 is insufficient, the heater 20 may be activated. Heater 20 may be an electric heater or it may be a burner or other heat source. When during that situation the amount of heat enthalpy that can be transferred to the EAS 30 is limited due to a temperature limit, part of a flow generated by the flow generator 40, e.g. an e-turbo, may be guided towards the exhaust line 13 directly, via bypass line 11, bypassing the engine 10, e.g. by means of a three-way valve in the intake line further illustrated below. An e-turbo can be controlled to achieve certain boost pressure for the engine intake line 12 and may be a turbo compressor of a known type, where mechanical energy derived from the exhaust turbine may be electrically boosted by an electric motor. The compressor may also be all-electric or may be hybrid — that is, the compressor can be mechanically driven by the turbine and at the same time boosted by an electric motor. The advantage of an e-turbo is that it is fully complied to generate massive amounts of air flow needed for sufficient transfer of enthalpy, e.g. in mass flow quantities exceeding 100 g/s. The control system 50 may calculate the amount of fuel or electric power delivered to the heater/burner, as percentage of the maximum capacity of the heater/heater. For example, control system 50 may control activation of the electric flow generator 40 as the heater enthalpy delivered to the exhaust line exceeds a maximum threshold value in dependence of an exhaust gas flow. This can be determined by a temperature sensor or a model, that determines a threshold temperature, in view of the exhaust gas flow, that is provided by the heater 20. Alternatively, or additionally, the control system may control activation of the electric flow generator as the exhaust gas flow is lower than a minimum threshold value, e.g. in view of a desired amount heat enthalpy.

The control system 50 may increase the air flow from the e-compressor or e-turbo and direct it directly into the exhaust line 13. The amount of air can thus be increased so that the heater/heater can be operated e.g. at a maximum capacity, without risking damage risks to the EAS 30 in view of a high temperatures, and thereby control the heater 20 as a function of a maximum heater capacity. The control system 50 controls the amount of flow, generated by the electric flow generator 40 guided towards the exhaust line 13 as function of the amount of mass flow required by the engine 10, the capability of the heater 20 and the capability of the flow generator 40, e.g. an e-turbo. It is noted that this type of air supply through an inlet opening in the exhaust line 13 is unlike feeding a heater with fresh air to increase the heater performance, e.g. by atomizing fuel in the heater and therewith increase the robustness of the flame, or supply air to realize a proper air/fuel ratio for proper combustion in the heater. In such cases the amount of air for such an application is very limited (−3-50 g/s, depending on the heater power), and there is no direct supply of intake air to the exhaust line which will not lead to a significant increase of enthalpy in situations where the heater heat power is limited by the temperature limit. In addition, a simple increase of fresh air mass flow in such systems will lead to improper fuel/air mixture leading to non-functioning of the heater. Furthermore, in such applications, fresh air is generated by electric flow generators typically not arranged in the intake line, that are not suitable for boosting the intake pressure of the engine 10. An important aspect of the invention is utilizing flow generator systems by systems, such a turbo compressor (i.e. an electric pre stage compressor or an e-turbo) already present in the engine system. A further important aspect is that the electric flow generator is not or only partly dependent on the mechanical power take of a turbine arranged in the exhaust channel, since the application has specific advantages at low exhaust flow speeds, when the turbine cannot render sufficient pumping energy for generating a sufficient fresh air mass flow. The electric flow generator 40, by its at least in part electrical powering is thus not fully dependent on power that can only be supplied at significant exhaust flows produced at relatively high load of ICE 10.

Advantageously the invention naturally uses the overcapacity, at low-load conditions of the engine, such as idling, of a flow generator to increase the mass flow in the exhaust, so that the heating power of the heater 20 is no longer limited by the temperature limit. By physical law :
P_heater=qm_exh×(exh_temp_ab—exh_temp bb)×cp
Where:
P_heater=heat enthalpy of heater/heater
qm_exh=exhaust mass flow
exh_temp_ab=exhaust gas temperature downstream of heater/heater
exh_temp bb=exhaust gas temperature upstream of heater/heater
cp=constant pressure heat capacity of the exhaust gasses

Since the temperature downstream of the heater/heater is often limited to ˜500 degC in order to prevent too high thermal stress of the EAS 30, the equation shows that the amount of heat enthalpy can be increased by increasing the exhaust mass flow. As a non limiting example, e.g. during engine idling the exhaust mass flow is normally limited to −20-50 g/s, which is lower than e.g. a desired 100 g/s. in such cases also, the exhaust gas temperature upstream of a heater/heater can be in the range of 100-150 degC, or even colder in the case of a cold-start event. In such a condition taking into account the maximum temperature downstream of the heater/heater, the maximum heat enthalpy may be limited to about 5 kW, which is far below a typical capacity of a heater, which could be in the order of 15-40 kW, e.g. 30 kW. To be able to deliver the heat power while keeping the temperature in acceptable limits, the exhaust flow may be increased, by supplying intake air, via the bypass line into the exhaust line at a rate higher than e.g. 50 g/s that is, where the electric flow generator is arranged to supply intake air to the exhaust line in excess of 50 or even 100 g/s.

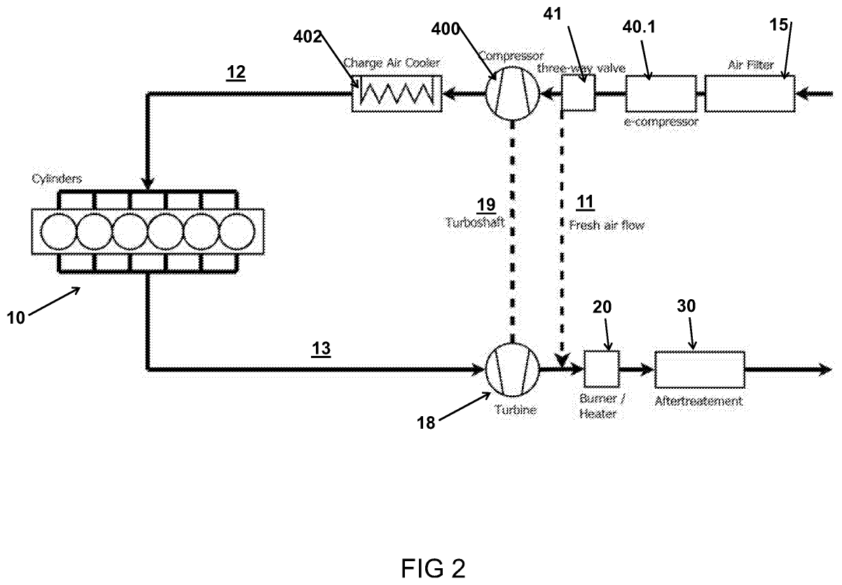

Turning to FIG. 2 an internal combustion engine 10 is illustrated with a conventional turbo compressor arrangement, i.e. a turbine 18 arranged in the exhaust line 13, that is mechanically coupled to a compressor 400 via a turbo shaft 19. In this example, the compressor can be of a conventional type. The compressor 400 boosts the pressure, via a charge air cooler 402 into the engine 10. In this example, e-compressor 40.1 functions as a prestage compressor of turbocompressor 400 arranged in the intake line 12 providing boost pressure to the internal combustion engine 10. The pre-stage e-compressor 40.1 is communicatively coupled, via a controllable three-way valve 41 to a bypass line 11 between the air intake 15 and an inlet opening in exhaust line 13, to supply intake air to the exhaust line 13 upstream of heater 20. If a control system detects that the EAS 30 is in need for heating up, burner 20 is activated and e-compressor 40.1 is activated, while opening the three way valve 40.2 to direct fresh air flow via bypass line 11. This can be executed by a feed forward control, e.g. implemented in hardware or software in a control system, geared to a standard acceptable flow provided to the heater 20 that allows the heater to burn 20 at its maximum heater capacity. It can also in a feedback loop control, e.g. by a flow controlled process, that increases the fuel in dependence of increased flow in the exhaust line 13 or by a temperature controlled process, that increases the flow in dependence of a measured or calculated threshold temperature of the heater 20 adjacent the exhaust line 13. Since heat transfer is most efficient at high temperatures, this latter option is a preferred mode.

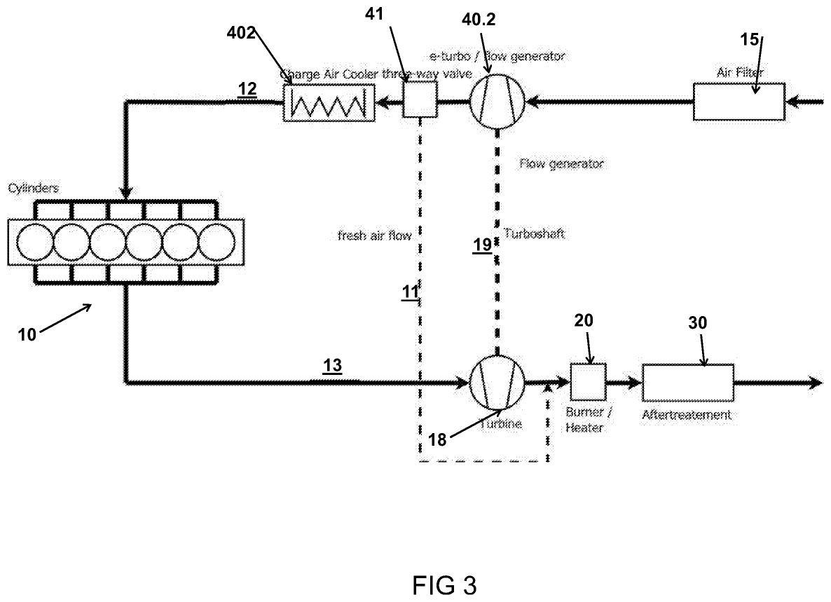

Turning to FIG. 3, in stead of a conventional compressor an e-turbo is arranged in the inake line 12, that is mechanically driven by turboshaft 19, but can also be powered by an electromotor. In this embodiment, accordingly, the electric flow generator comprises a hybrid electric turbine (e-turbo) 40.2 for providing a boost pressure for the internal combustion engine 10. The e-turbo is arranged in a fluid communication path in intake line 12 between the air intake 15 and an inlet opening arranged in the exhaust line 13 to supply intake air to the exhaust line 13. Thus, when the exhaust flow in exhaust line 13 is relatively low, e.g. due to engine idle conditions, the e-turbo is able to generate a sufficient flow in the intake line 12, that is not consumed by engine 10, but bypassed, via bypass line 13 into the exhaust line, upstream of heater 20. Bypass line 11 can be selectively controlled to provide pressurized intake air from the e-turbo 40.2, as an electric flow generator , via an inlet opening in exhaust line 13, to supply intake air to the exhaust line 13 for transporting heat generated by the heater 20 towards the aftertreatment system 30.

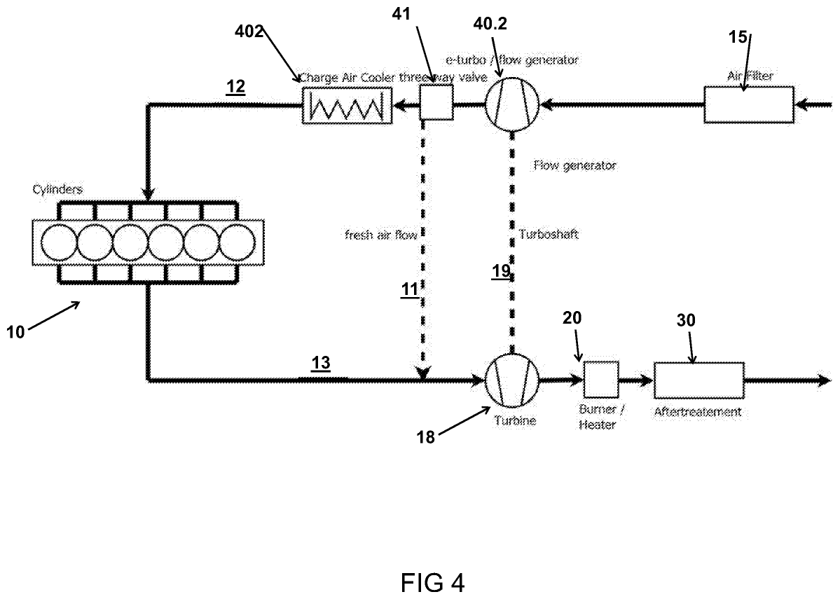

FIG. 4, while structurally comparable to FIG. 3 has a different injection point of the bypass line 11. In FIG. 3, the air flow is injected downstream of the turbine 18, where in FIG. 4 it is injected upstream of the turbine 18. There may be benefits in either configuration, the configuration in FIG. 3 minimizing flow losses due to the turbine interaction (when relatively low flow can be provided), while the FIG. 4 embodiment may be structurally beneficial to allow easy access to the exhaust line 13 via turbine 18.

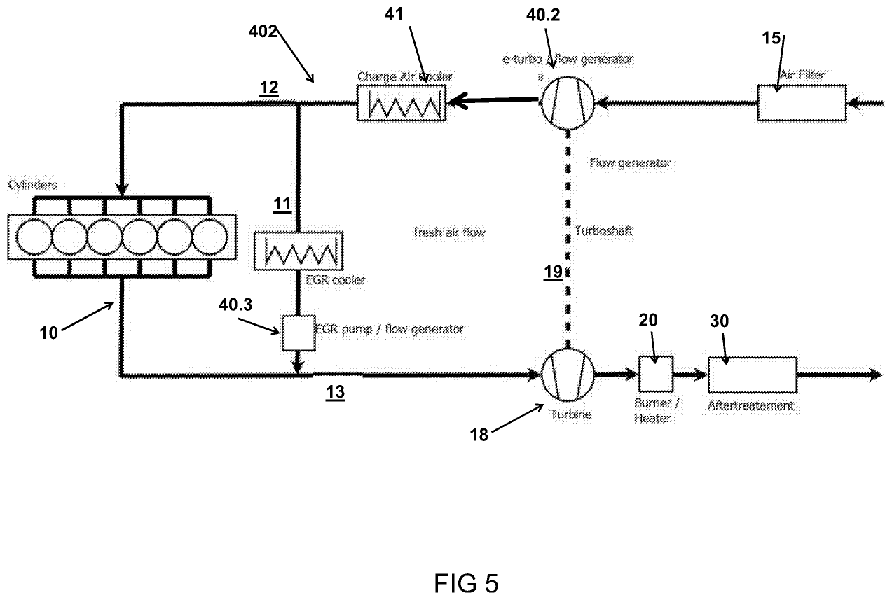

FIG. 5 shows yet another configuration of an electric flow generator 40.2 arranged in the intake line and flow generator 40.3 arranged in the bypass line 11. In the embodiment, the internal combustion engine 10 comprises an exhaust gas recirculation (egr) line 11 for use, in egr mode, to supply exhaust gas to the intake line 12; and wherein, in a bypass mode, the bypass line 11 is formed by the exhaust gas recirculation line to supply intake air to the exhaust line 13. The flow generators 40.2 and 40.3 are provided between the air intake 15 and an inlet opening in the exhaust line 13 to supply intake air to the exhaust line. Preferably, in the example, flow generator 40.2 arranged in the intake line 12 is formed by an e-turbo of the type previously described. The egr line/bypass line 11 comprises an exhaust gas recirculation pump 40.3 arranged to reverse a flow in the egr line to selectively provide pressurized intake air from the electric flow generator 40.2 and 40.3 via an inlet opening in the exhaust line 13 to supply intake air to the exhaust line 13 for transporting heat generated by the heater 20 towards the aftertreatment system 30.

FIG. 6 further exemplifies a control scheme 500 executed by control system 50 (see FIG. 1) for selective control of a bypass line to provide pressurized intake air from an electric flow generator, via an inlet opening to supply intake air to an exhaust line for transporting heat generated by the heater towards the aftertreatment system. The control flow has a first control mode Q1 that continuously or at least at intermittent intervals queries whether a rapid heat-up mode is requested. Such a query is dependent on vehicle state operations such as engine temperature, engine load and may be active in initial stages of an engine control after cold start. If the query results in a ‘no’ the bypass mode is not activated and normal operation of the flow generator and re-routing valve are assumed in the ‘N’ condition to be communicated with an engine control unit.

If the query results in a ‘yes’; a further query mode Q2 is executed wherein it is decided whether the enthalpy transfer is limited by exhaust gas temperature limit. That is, if the burner already has a maximum allowable temperature, no further temperature increase is allowed and in state S1 fresh air flow is increased and routed towards exhaust directly via the bypass mode. In case the burner does not have a maximum temperature, in state S2, the temperature is increased while maintaining normal operation of the flow generator and re-routing valve, as in the normal condition.

1. An internal combustion engine comprising:
an exhaust line configured to receive exhaust gas from the internal combustion engine;
an intake line configured to supply pressurized air from an air intake to the internal combustion engine;
a heater disposed adjacent the exhaust line to generate heat that is transported via the exhaust line to an exhaust aftertreatment system;
a bypass line controllably connecting the intake line to the exhaust line to bypass the engine, the bypass line in fluid communication with the exhaust line through an inlet opening in the exhaust line;
an electric flow generator arranged in the intake line and/or bypass line between the air intake and the inlet opening to supply intake air to the exhaust line; and
a control system arranged to selectively control the bypass line to provide pressurized intake air from the electric flow generator, via the inlet opening to supply intake air to the exhaust line for transporting heat generated by the heater towards the aftertreatment system; and
wherein the control system is arranged to control activation of the electric flow generator as the heater enthalpy exceeds a maximum threshold value while controlling the heater at maximum heater capacity.

2. The internal combustion engine according to claim 1, wherein the maximum heater temperature is thresholded at a temperature value of air transported towards the aftertreatment system higher than 500° C.

3. The internal combustion engine according to claim 1, wherein the control system is arranged to control activation of the electric flow generator as the exhaust gas flow is lower than a minimum threshold value.

4. The internal combustion engine according to claim 1, wherein electric flow generator comprises a prestage compressor of a turbocompressor arranged in the intake line providing boost pressure to the internal combustion engine.

5. The internal combustion engine according to claim 1, wherein the electric flow generator comprises a hybrid electric turbine for providing a boost pressure for the internal combustion engine.

6. The internal combustion engine according to claim 1, wherein the internal combustion engine comprises an exhaust gas recirculation (egr) line for use, in egr mode, to supply exhaust gas to the intake line; and wherein, in a bypass mode, the bypass line is formed by the exhaust gas recirculation line to supply intake air to the exhaust line.

7. The internal combustion engine according to claim 6, wherein the egr line comprises an exhaust gas recirculation pump, the pump arranged to reverse a flow in the egr line to supply intake air to the exhaust line.

8. The internal combustion engine according to claim 1, wherein the electric flow generator is arranged to supply intake air to the exhaust line in excess of 50 g/s.

9. The internal combustion engine according to claim 1, wherein heater enthalpy exceeds 5 kW.

10. The internal combustion engine according to claim 1, wherein the bypass line controllably connects the inlet line to the exhaust line to bypass the engine by a threeway valve arranged in the inlet; upstream of the electric flow generator.

11. The internal combustion engine according to claim 1, wherein the bypass line controllably connects the inlet line into a turbine arranged in the exhaust line.

12. The internal combustion engine according to claim 1, wherein the bypass line controllably connects the inlet line into an inlet port in the exhaust line upstream of a turbine arranged in the exhaust line.

13. The internal combustion engine according to claim 1, wherein the bypass line controllably connects the inlet line into an inlet port in the exhaust line downstream of a turbine arranged in the exhaust line.

14. The internal combustion engine according to claim 9, wherein the heater enthalpy is increased to about 20-30 kW.
